(19) United States
(12) Patent Application Publication
(10) Pub. No.: US 2021/0277998 A1
(43) Pub. Date: Sep. 9, 2021

(54) Device for Sealing an Object

(71) Applicant: Universitaet Stuttgart, Stuttgart (DE)

(72) Inventors: Lothar Hoerl, Bietighelm-Bissingen (DE); Nino Dakov, Stuttgart (DE); Mario Stoll, Stuttgart (DE); Frank Bauer, Leinfelden-Echterdingen (DE)

(73) Assignee: Universitaet Stuttgart, Stuttgart (DE)

(21) Appl. No.: 16/468,267

(22) PCT Filed: Nov. 23, 2017
(86) PCT No.: PCT/EP2017/080186

§ 371 Date: Jun. 10, 2019

(30) Foreign Application Priority Data
Dec. 15, 2016 (DE) 10 2016 124 457.0

(51) Int. Cl. F16J 15/3228

(52) U.S. Cl. CPC F16J 15/3228

(57) ABSTRACT

The invention relates to a device for sealing an object to be sealed, in particular for sealing a rotating shaft, which device has a sealing body, which has a sealing side facing the object to be sealed and a back side facing away from the object to be sealed. On the back side, the sealing body has at least one element that changes the stiffness of the sealing body, which element changes the contact pressure between the sealing body and the object to be sealed.

The invention relates to a device for sealing an object to be sealed, in particular for sealing a rotating shaft, having a sealing body which has a sealing side that faces the object to be sealed, and a rear side that faces away from the object to be sealed.

The most varied embodiments of such sealing devices are known from the prior art. Some of these known devices will be discussed in more detail hereunder:

DE 10 2006 058 699 A1 describes a cover element or sealing element, respectively, for sealing between a construction element that delimits a passage opening for a shaft and the shaft that passes through the passage. opening. The sealing element for sealing in relation to the shaft comprises a dynamic sealing region, and for bearing in a static manner in relation to the construction element comprises a static sealing region. The dynamic sealing region is configured from an elastomer material and comprises a sealing portion which seals along a shaft portion, the internal shell of said sealing portion for conveying the leakage fluid back to a space to be sealed comprising a return conveying structure.

A similar sealing element for sealing a rotating shaft on a passage opening of a housing part, having a stiffening part and an elastomer part that is connected to the stiffening part is described in DE 10 2007 036 625 A1, said sealing element having a first sealing region for bearing in a statically sealing manner on the housing part, and said sealing element having a second sealing region having a sealing portion that is configured and provided for bearing in the sealing manner on the shaft, said sealing portion for conveying back a leakage fluid into a space to be sealed comprising a thread-type return conveying structure.

DE 10 2010 042 555 A1 describes a radial shaft seal ring which has a stiffening ring and an elastomer part that is connected to the stiffening ring, said elastomer part having a seal lip having a first sealing portion that for conveying back a leakage fluid in the case of a rotating shaft is provided with a thread-type return conveying structure, and a second sealing portion which for bearing in a gas-tight manner on the stationary shaft has a sealing face in the shape of a circular-cylindrical shell, said sealing face in turn having a microstructure.

A radial shaft seal ring having a stiffening ring and an elastomer part that is connected to the stiffening ring is known from DE 10 2010 061 819 A1, said elastomer part having a dynamic seal lip having a radial seal lip portion and an axial seal lip portion, wherein the axial seal lip portion for bearing in a sealing manner on a shaft has a sealing edge which is disposed on an internal shell wall of the axial seal lip portion that faces the shaft.

WO 2012/095227 A1 describes a radial shaft seal ring having a reinforcement ring and an elastomer part that is connected to the reinforcement ring, said elastomer part supporting a dynamic seal lip which has a sealing edge composed of PTFE and which bears on a shaft that is sealed by the radial shaft seal ring.

A drive shaft of an axial piston machine which is sealed by means of a radial shaft sealing system is known from DE 10 2010 026 157 A1, said radial shaft sealing system having a radial shaft seal ring and a counter running face, the surface of the latter having a hydrodynamic return conveying structure which is provided with a hard, diamond-like surface coating.

A release bearing of a friction clutch that is configured as a diaphragm spring clutch is described in DE 10 2009 049 466 A1. Said release bearing has a bearing interior space which is filled with bearing grease and which in an axial manner is closed by a seal which is rigidly fastened to the outer ring of the bearing and by way of the sealing edge of a seal lip bears on a sealing face of the inner ring of the bearing. In order for the sealing effect to be increased, the seal lip of the sealing is provided with a return conveying structure which is disposed so as to axially neighbor the sealing edge and is operatively connected to the assigned sealing face.

A mechanical seal for sealing the passage location of a rotating shaft through a wall is known from EP 0 592 462 B1. The mechanical seal has return conveying structures which has a plurality of return conveying points that lie at geometrically defined positions.

DE 101 09 320 A1 describes a radial shaft seal ring having a sealing element composed of plastics material, in particular composed of a PTFE compound, which has a seal lip which by way of a portion bears in a sealing manner in relation to the medium side on the surface of a shaft. A contact pressure device which holds the portion of the seal lip by way of contact pressure of a radially inwardly directed force on the surface of the shaft is provided on the medium side of the seal lip.

An elastomer shaft seal ring in which the rear side of the sealing region is designed so as not to be smooth is described in DE 10 2005 037 568 A1.

A shaft seal having a plurality of lips in one of the lips has concave clearances is known from DE 102 33 396 A1.

Accordingly, the known radial shaft seal rings are often provided with so-called return conveying structures which should have the effect that fluid that is entrained by the rotating shaft. is deflected axially in the direction of the media side, or of the site to be sealed, respectively, such that return conveying of the fluid and thus sealing results in the dynamic state. This principle in the case of radial shaft seal rings that are composed of rubber to some extent also functions without explicitly created return conveying structures, since rubber material per se, by virtue of friction, forms said structures.

The known seal rings that on the sealing side facing the object to be sealed are provided with such return conveying structures, or the seal rings in which the return conveying structures are configured in a self-acting manner, in most instances are composed of a material that is based on rubber. However, in the case of rubber seal rings the fact that said rubber seal rings, in the case of the to some extent high contact pressure forces required, become very hot on account of the friction with the rotating shaft and can be damaged is problematic.

For this reason, it is to some extent attempted to use seal rings composed of other materials, in particular materials which are more resistant to heat, such as polytetrafluoroethylene, for example. Examples pertaining thereto are also described above. Since the seals that are composed of these materials are indeed more resistant in thermal and chemical terms, but are also substantially harder than rubber seal rings, said return conveying structures in the case of these seal rings are not created in a self-acting manner but have to be incorporated in said seal rings, this leading to very high requirements in terms of production and assembly technology. Moreover, on account of the greater hardness of this material, it can arise that the sealing side, or the contact face, respectively, even in the case of comparatively minor geometric deviations from the nominal state, potentially no longer fully bears on the object to be sealed, and no optimal tightness is achieved on account thereof.

According to the prior art, spiral grooves by way of which the fluid is to be conveyed back are to some extent used in the case of such PTFE seal rings. While said spiral grooves have a rather adequate effect in the case of rotating shafts, thus in the case of dynamic sealing, leakages can however arise in the case of the stationary shaft, thus in the case of static sealing, since the fluid by way of the spiral grooves can make its way from the fluid side or the media side, respectively, to the air side.

It is therefore an object of the present invention o achieve a device for sealing an object to be sealed, in particular for sealing a rotating shaft, which guarantees reliable sealing in the most varied operating states.

This object is achieved according to the invention by the features mentioned in claim 1.

On account of the element according to the invention which modifies the rigidity of the sealing body and which is disposed on the rear side of the sealing body, a non-uniform distribution of the surface pressure in the sealing gap between the sealing body of the device according to the invention and the object to be sealed is achieved. Very narrow and converging gaps between the sealing body and the object to be sealed result on account of said non-uniform distribution of the surface pressure and on account of the pressure differentials that result in the dynamic state within the sealing gap, the fluid entrained in the case of a rotating shaft being deflected in the axial direction by way of said gaps and, on account thereof, being able to be conveyed back to the fluid side or media side, respectively. A dynamic sealing effect results on account of the resulting return pumping effect of the fluid that is deflected in a targeted manner in the direction of the fluid side or media side, respectively.

The described creation of a gap between the sealing body and the object to be sealed can also result only in the dynamic state, for example in the case of rotation of the shaft. On account thereof, very effective sealing in the specific dynamic application can be achieved by way of a relatively minor constructive complexity.

On account of the disposal according to the invention of the element which modifies the rigidity of the sealing body on the rear side of the sealing body, thus on the side of said sealing body that is opposite the sealing side, the surface of the sealing side per se is not modified, so that said surface of the sealing side in the specific static application, thus for example in the switched-off state of a machine equipped with a device according to the invention, bears completely on the object to be sealed and a high tightness is achieved.

The solution according to the invention, by virtue of the simple constructive design thereof, can be used for the most varied application purposes, since said solution can be readily adapted to the respective requirements.

On account of the at least one element which modifies the rigidity of the sealing body running obliquely to a longitudinal axis of the sealing body, the fluid stream is imparted a direction away from the circumferential edge. The indication “obliquely to a longitudinal axis of the sealing body” comprises a linear as well as an arcuate or curved, respectively, profile of the element which modifies the rigidity of the sealing body. The plan view of the sealing system herein is defined such that the circumferential edge of the sealing body runs orthogonally to the longitudinal axis of the sealing body.

In one very advantageous refinement of the invention it can be provided that a plurality of elements which modify the rigidity of the sealing body are disposed so as to be distributed about the circumference of the sealing body. A uniform sealing effect about the entire circumference of the object to be sealed can be achieved on account thereof, this being particularly advantageous in the case of a rotating shaft.

An improvement in terms of static sealing results when the at least one element which modifies the rigidity of the sealing body has a spacing from a circumferential edge of the sealing body. In this case, the circumferential edge of the sealing body remains unmodified and guarantees effective sealing in all specific applications. However, said spacing is not mandatory, and the at least one element which modifies the rigidity of the sealing body could also run up to a circumferential edge of the sealing body.

In one embodiment of the invention which can be implemented in a very simple manner it can be provided that the at least one element which modifies the rigidity of the sealing body is formed by a modification of the material thickness of the sealing body.

A design embodiment which is particularly relevant in terms of practical use herein can exist in that the at least one element which modifies the rigidity of the sealing body is configured as a depression. Depressions of this type can already be incorporated in the sealing body in the production of the latter, and accordingly represent an only very minor manufacturing complexity.

When the at least one depression in one further advantageous design embodiment of the invention has a height profile, the latter can be adapted to different requirements in terms of sealing and it can be achieved that the fluid is conveyed in the desired direction. In principle, a profile of this type is conceivable in the circumferential direction as well as in the axial direction.

In terms of the effect of the element which modifies the rigidity of the sealing body it has proven particularly advantageous herein for the depression to have a depth of 10 to 90%, preferably 30 to 90%, of the material thickness of the sealing body.

Alternatively or additionally to the embodiment of the element which modifies the rigidity of the sealing body as a depression, it can be provided that the at least one element which modifies the rigidity of the sealing body is configured as an elevation. Such elevations can also be generated already in the production of the sealing body and have a desired effect on the surface pressure that exists between the sealing body and the object to be sealed.

In order for the elevation to be able to be adapted to different requirements in terms of sealing, it can be provided that the at least one elevation has a height profile. Conveying of the fluid in the desired direction can thus furthermore be achieved. In principle, a profile of this type is conceivable in the circumferential direction as well as in the axial direction.

A desired sealing effect herein can be achieved when the elevation exceeds the material thickness of the sealing body by 5 to 100%, preferably 25 to 100%.

Additionally or alternatively to the modification of the material thickness of the sealing body it is also possible for the at least one element which modifies the rigidity of the sealing body to be formed by a material that is dissimilar to the material of the sealing body. The influence on the surface pressure between the sealing body and the object to be sealed can also be achieved by way of such a material replacement. Combinations of the different embodiments for forming the element which modifies the rigidity of the sealing body herein are possible on one and the same sealing body.

The indication “obliquely to a longitudinal axis of the sealing body” is particularly advantageously referred to in particular when the at least one element which modifies the rigidity of the sealing body in the plan view runs obliquely at an angle between 0.1° and 89.9°, or between −89.9° and −0.1° to the longitudinal axis of the sealing body. A desired sealing effect can be achieved in this way by an axial deflection of the fluid to be sealed.

For specific applications it can be advantageous when the at least one element which modifies the rigidity of the sealing body is composed of a plurality of geometric basic shapes. Said geometric basic shapes can be composed of one or a plurality of inclines, arcs, circles, or any conceivable shapes.

One further advantageous design embodiment of the invention can exist that at least one element which modifies the rigidity of the sealing body in the plan view runs obliquely at a positive angle to the longitudinal axis of the sealing body, and at least one element which modifies the rigidity of the sealing body in the plan view is disposed counter to the former, obliquely to the longitudinal axis of the sealing body. This permits the device according to the invention to be adapted to specific sealing requirements.

When the at least one element which modifies the rigidity of the sealing body has two inclines of which one, in the plan view, has a positive angle in relation to the longitudinal axis of the sealing body, and of which the other, in the plan view, has a negative angle in relation to the longitudinal axis of the sealing body, sealing which is advantageous in the case of specific applications can thus be achieved.

Furthermore, when at least one of the elements which modifies the rigidity of the sealing body and which is disposed so as to be distributed about the circumference of the sealing body, in the plan view, runs in a direction counter to the other elements which modify the rigidity of the sealing body, obliquely to the longitudinal axis of the sealing body, thus has a positive and a negative angle, the device can be used for two different rotating directions of a rotating shaft.

An embodiment of the invention which is particularly advantageous in terms of conveying the fluid in the desired direction results when the at least one element which modifies the rigidity of the sealing body widens away from a circumferential edge of the sealing body. In principle, a parallel profile of the two lateral peripheries of the at least one element which modifies the rigidity of the sealing body is also conceivable.

It can furthermore be provided that the sealing body comprises polytetrafluoroethylene. The solution according to the invention is interesting in particular for PTFE; seals since problems in terms of the return conveying of the fluid often arise specifically in the case of such seals. In principle, the solution according to the invention can also be used in other materials that are usually used for seals. In principle, the solution according to the invention can also be used in other materials that are usually used for seals.

When the sealing body on the sealing side is furthermore configured so as to be substantially smooth, this thus represents an embodiment which is simple in terms of manufacturing technology, on the one hand, and positive basic sealing of the location to be sealed is guaranteed, on the other hand. The indication “smooth” refers to such an embodiment of the face on the sealing side of the sealing body which does not have any incorporated or applied structures. In principle, this is thus a sealing side which in the original state thereof is planar or flat, respectively, wherein the curvature or bending line, respectively, of the sealing body which results from use or assembling, respectively, is not considered.

The advantageously effects of the device according to the invention can also result when, alternatively or additionally to the embodiment of the element which modifies the rigidity of the sealing body as a depression or elevation, the at least one element which modifies the rigidity of the sealing body is configured as a cavity. Such cavities, or hollow members, respectively, can also be generated already in the production of the sealing body, and have a desired effect on the surface pressure that exists between the sealing body and the object to be sealed.

A desired sealing effect herein can be achieved when the cavity occupies 20% to 80% of the material thickness of the sealing body.

Additionally or alternatively to a cavity, the cavity can also be filled with an additional material.

Exemplary embodiments of the invention are schematically illustrated hereunder by means of the drawing.

### IN THE DRAWINGS

FIG. 1 shows a first embodiment of the device according to the invention;

FIG. 2 shows an enlarged illustration as per the line 1I-II from FIG. 1;

FIG. 3 shows a perspective view of a second embodiment of the device according to the invention;

FIG. 4 shows an illustration of the contact region between the device according to the invention and the object to be sealed;

FIG. 5 shows a third embodiment of the device according to the invention;

FIG. 6 shows an enlarged illustration as per the line VI from FIG. 5;

FIG. 7 shows a fourth embodiment of the device according to the invention;

FIG. 8 shows an enlarged illustration as per the line VIII from FIG. 7;

FIG. 9 shows a fifth embodiment of the device according to the invention;

FIG. 10 shows an enlarged illustration as per the line X from FIG. 9;

FIG. 11 shows a sixth embodiment of the device according to the invention;

FIG. 12 shows an enlarged illustration as per the line XII from FIG. 1

FIG. 13 shows an alternative to the embodiment of FIG. 12;

FIG. 14 shows a further illustration of the device according to the invention; and

FIG. 15 shows various geometric basic shapes for forming the at least one element which modifies the rigidity of the sealing body,

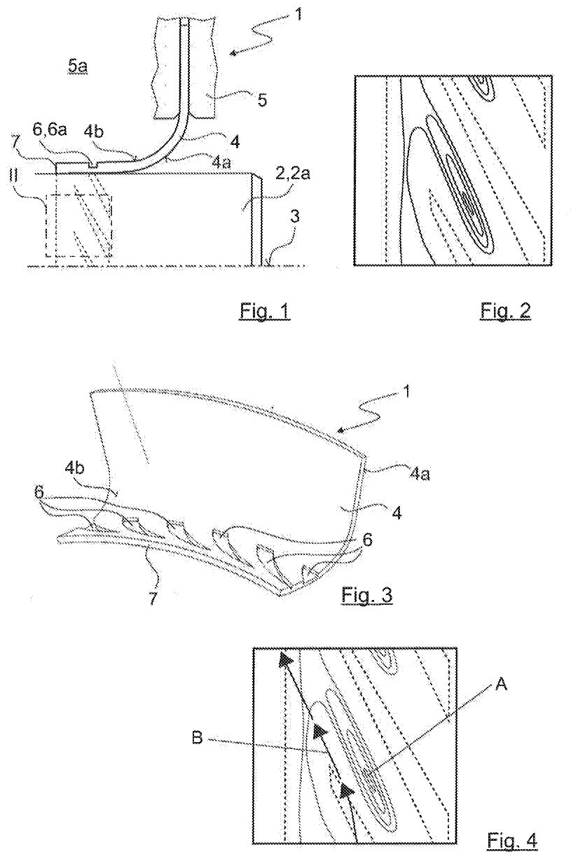

FIG. 1 shows a device 1 for sealing an object 2 to be sealed, in the present case a shaft 2a which rotates about a longitudinal axis 3. The device 1 has a sealing body 4 which has a sealing side 4a that faces the object 2 to be sealed and partially contacts the latter, and a rear side 4b that faces away from the object 2 to be sealed. The sealing body 4 on the end thereof that faces away from the object 2 is held in a component 5 (only schematically indicated). The component 5 can be, for example, a housing in which the rotating shaft 2a is mounted. Of course, other installation possibilities or types of application, respectively, of the device 1 are also conceivable.

The sleeve-type installation situation of the device 1 illustrated in FIGS. 1, 4, 6, 8, and 10 is to be considered purely exemplary, and the device 1 in terms of the installation direction as well as the disposal of said device 1 in relation to the component 5 and of the object 2 can in principle be installed or disposed in the most varied manners, respectively, so as to achieve the sealing described hereunder. In principle, all geometric shapes of the sealing body 4 in which the circumferential forces on the object 2 are created by a widening of the sealing body 4 are conceivable.

As can be seen in FIG. 1 and in particular in the perspective illustration of FIG. 3, the sealing body 4 on the rear side 4b has at least one element 6 which modifies the rigidity of the sealing body 4. The element 6 which modifies the rigidity of the sealing body 4, and which hereunder for the sake of simplicity is simply referred to as the element 6, can be configured in various ways, of which some will be described hereunder. A plurality of elements 6 are provided in all of the embodiments of the device 1 described herein. The elements can also be referred to as “rear structures” since said elements are situated on the rear side 4b of the sealing body 4. In principle, an embodiment in which the device has only one of the elements 6 is also conceivable.

The region of the sealing body 4 that is in contact with the object 2 to be sealed is thus imparted rigidity jumps by the elements 6, said rigidity jumps leading to the surface pressure of the sealing body 4 acting on the object 2 to be sealed being influenced, and thus to the gap formation between the sealing body 4 and the object 2 to be sealed being influenced. It is thus a common feature of all of the embodiments that the element 6 is configured such that said element 6 modifies the surface pressure between the sealing body 4 and the object 2 to be sealed. A varying surface pressure thus results by way of the face of the sealing body 4 and is in contact with the object 2 to be sealed. The elements 6 influence the surface pressure of the sealing body 4 on the object 2 to be sealed in each case in a localized manner such that a certain wedge gap is created in this region, or is configured on account of the entrainment stream in the circumferential direction of the shaft 2a in the rotation of the latter, respectively, a fluid which is to be kept in a specific region by the device 1 being able to be conveyed back into said region by way of said wedge gap. The fluid can be, for example, oil or another liquid, optionally also a gas. The illustration in the figures is in each case a region to the left of the device 1. This region forms, for example, the interior space 5a of the housing or component 5, respectively. It is moreover a common factor of all of the embodiments that the sealing body 4 on the sealing side 4a is configured so as to be substantially flat. This is not mandatory, and the the sealing body 4 could also have certain structures on the sealing side 4a.

The sealing body 4 is preferably composed of polytetrafluoroethylene (PTFE). In principle, the at least one element 6 which modifies the rigidity of the sealing body 4 could however also be used in sealing bodies 4 which are composed of other materials such as, for example, elastomers. For example, the sealing body 4 could also be composed of polyurethane. Further potential but not exclusive materials or material combinations, respectively, are NBR, FKM, ACM, VQM, PE, PEEK, in each case also in combinations and coatings and/or having fillers such as, for example, carbon blacks, plastics materials, silicates, and similar.

It can be seen in FIG. 3 that a plurality of elements 6 which modify the rigidity of the sealing body 4 are disposed so as to be distributed about the circumference of the sealing body 4. The number and the distribution of the elements 6 according to FIG. 3 is however to be considered purely exemplary and can also be differently embodied, depending on the respective specific application.

Furthermore, the elements 6 in the case of all of the embodiments illustrated in the figures are disposed such that said elements 6 have a spacing from a circumferential edge 7 of the sealing body 4 that faces the interior space 5a of the component 5. However, this is not mandatory, and the elements 6 can optionally also run up to the circumferential edge 7 of the sealing body 4. A leakage of the fluid is prevented on account of the spacing of the elements 6 from the circumferential edge 7, since the sealing body 4 in the region of the circumferential edge 7 bears uniformly on the object 2 to be sealed.

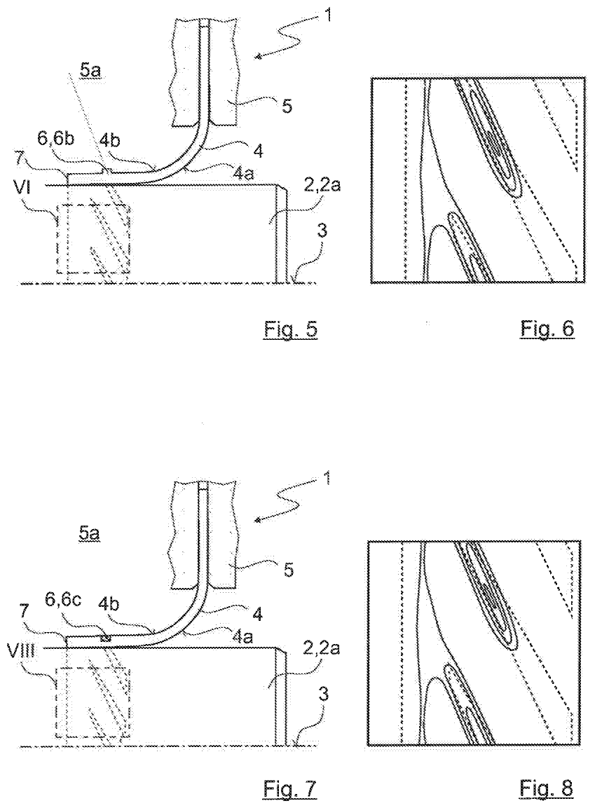

In the case of the embodiments illustrated in FIGS. 1 to 3 as well as in FIGS. 4 and 5, the element 6 is configured by modification of the material thickness of the sealing body 4.

In the case of the embodiment of FIGS. 1 to 3, the element 6 which modifies the rigidity of the sealing body 4 is embodied as a depression 6a. A reduction in the rigidity of the sealing body 4 in this region is achieved on account of the at least one depression 6a, or by the depressions 6a that are disposed so as to be distributed about the circumference of the sealing body 4, respectively. On account of the depression 6a and the reduction in the rigidity that results on account thereof in the region of said depression 6a, the respective region between the elements 6 has a greater rigidity. The at least one depression 6a (in a manner not illustrated) can have a height profile, and thus have dissimilar levels in terms of the height or depth of said depression 6a, for example. Such a profile is conceivable in the circumferential direction as well as in the axial direction.

The depression 6a preferably has a depth of 10 to 90%, in particular 30 to 90%, of the material thickness of the sealing body 4. For example, when the sealing body 4 thus has a material thickness of 2 mm, the depth of the depression 6a is 1 to 1.6 mm. The material of the sealing body 4 which remains in the region of the sealing side 4a and which is in contact with the object 2 to be sealed, in this case accordingly is still 0.4 to 1 mm. These herein are of course purely exemplary indications.

Such depressions 6a that form the elements 6 can already be generated in the production of the sealing body 4, thus in the primary forming of the latter. The primary forming of the sealing body 4 can be performed, for example, by sintering or injection molding. Alternatively, the elements 6 can also be generated by an embossing, forming, subtractive machining or laser machining,

The modification of the surface pressure between the sealing body 4 and the object 2 to be sealed resulting on account of the element 6 in FIG. 2 is illustrated in an enlarged manner by means of isobars, thus lines of identical pressure, or in this case identical surface pressure, respectively. FIG. 2 herein shows the isobars resulting on account of the element 6 illustrated in FIG. 1. It can be seen from the isobars that the leaking fluid, or the fluid tending to leak, respectively, by virtue of the pressure profile between the sealing body 4 and the object 2 to be sealed is diverted in the direction of the interior space 5a and can be conveyed back. The profile of the elements 6 can also be seen in the enlargement of FIG. 2. Said profile can furthermore also be derived from FIG. 1 and, in the case of the embodiment of FIGS. 1 to 3, also from the perspective illustration of FIG. 3. It can be seen that the element 6 which modifies the rigidity of the sealing body 4 widens away from the circumferential edge 7 of the sealing body 4. Conversely, the element 6, or in the case of the embodiment of FIGS. 1 to 3 the depression 6a, respectively, tapers off in the direction toward the circumferential edge 7. This is a particularly effective embodiment of the element 6 which modifies the rigidity of the sealing body 4; however, embodiments in which the two lateral peripheries of the element 6 which modifies the rigidity of the sealing body 4 run so as to be mutually parallel are also conceivable.

Furthermore, the depressions 6a, in the plan view, run obliquely to the longitudinal axis 3 of the rotating shaft 2a, said longitudinal axis 3 in the present case also representing the longitudinal axis of the sealing body 4. On account of this profile of the elements 6, a wedge-shaped gap results between the sealing body 4 and the object 2 to be sealed, on account of which fluid can be conveyed back. In other words, the fluid stream is imparted a direction toward the circumferential edge 7 on account of this embodiment of the elements 6. Optionally, it would also be possible for some of the elements 6 to be disposed counter to the oblique position of the same illustrated, such that the device 1 could be used for two different rotating directions of the rotating shaft 2a.

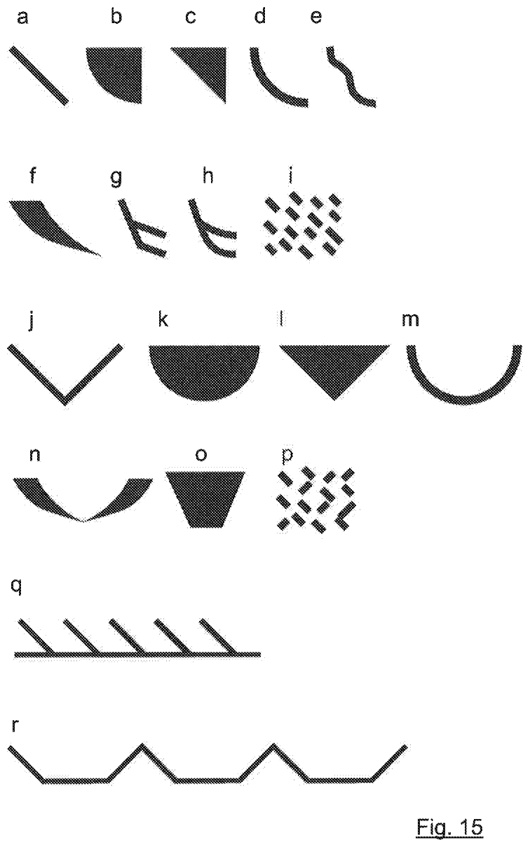

For specific applications it can be advantageous for the at least one element 6 which modifies the rigidity of the sealing body 4 to be composed of a plurality of geometric basic shapes. Said geometric basic shapes can be composed of one or a plurality of inclines, arcs, circles, or any conceivable shapes. Potential but not exclusive geometric shapes are illustrated in FIG. 15. Positions a-d show simple geometric shapes pertaining to how an element 6 which modifies the rigidity of the sealing body 4 can be designed. Positions e-h show elements 6 which modify the rigidity of the sealing body 4 and which are composed of assembled arcs or assembled straight lines. Position i shows elements 6 which modify the rigidity of the sealing body 4 and which in the plan view are disposed so as to be distributed in a stochastic manner by way of positive or negative angles in relation to the longitudinal axis of the sealing body 4. Positions a-i herein in the plan view are asymmetrical in relation to the longitudinal axis of the sealing body 4. Symmetrical elements 6 which modify the rigidity of the sealing body 4, as illustrated in positions j-o, and which can be assembled from the asymmetrical elements shown in an exemplary manner are also conceivable but not exclusive. Position p shows elements 6 which modify the rigidity of the sealing body 4 and which in the plan view are disposed so as to be distributed in a stochastic manner by way of positive and negative angles in relation to the longitudinal axis of the sealing body 4. Combinations corresponding to positions q and r are also conceivable but not exclusive. The elements 6 can overlap and be contiguous and be formed from the most varied geometric shapes.

The ratio of the height of the resulting sealing gap to the length of the latter in the direction of longitudinal axis 3, the latter being a function of the length of the respective element 6 in the direction of the longitudinal axis 3, can be very low and can be, for example, between 1:100 and 1:10000. The length of the element 6 in the direction of the longitudinal axis 3 can accordingly be several mm.

FIG. 4 shows the contact region between the device 1, or the sealing body 4, respectively, and the object 2 to be sealed, or the shaft 2a, respectively. A non-uniform pressure distribution which in FIG. 4 is identified as isobars A results on account of the above-described rear structures on the rear side 4b of the sealing body 4. The fluid entrained on account of the rotation of the shaft 2a is axially deflected on account of the non-uniform pressure distribution and can be conveyed in the direction of the space to be sealed, in this case thus the sealing side, this being illustrated by the arrows identified by “B”. On account thereof, the sealing effect is ensured in the dynamic state, thus in the rotation of the shaft 2a.

In the case of the embodiment illustrated in FIGS. 5 and 6, the element 6 which modifies the rigidity of the sealing body 4 is configured as an elevation 6b. An increase in the rigidity of the sealing body 4 in this region results on account of the at least one elevation 6b, or on account of the elevations 6b that are disposed so as to be distributed about the circumference of the sealing body 4, respectively. In the case of an increased rigidity, an increased surface pressure of the sealing body 4 on the object 2 to be sealed results, and the return conveying structures are created between the elements 6. The at least one elevation 6b (in a manner not illustrated) can have a height profile, and thus can achieve dissimilar levels in terms of the height or depth of said elevation 6b, for example. Such a profile is conceivable in the circumferential direction as well as in the axial direction.

In a manner similar to that of the depression 6a according to the embodiments of FIGS. 1 to 3, the elevation 6b also widens away from the circumferential edge 7. Furthermore, the elevations 6b also run obliquely to the longitudinal axis 3 of the rotating shaft 2a, said longitudinal axis 3 also representing the longitudinal axis for the sealing body 4.

The elevation 6b preferably exceeds the material thickness of the sealing body 4 by 5 to 100%, in particular 25 to 100%, such that the desired effect in terms of the modification of the surface pressure of the sealing body 4 on the object 2 to be sealed is achieved. In the case of a sealing body 4 having a material thickness of 2 mm this means that the height of the elevation 6b is 0.5 to 2.0 mm. The material thickness of the sealing body 4 in the region of the elevation 6b in this case is accordingly 2.5 mm to 4.0 mm. Of course, these indications are to be considered purely exemplary. Superelevations which exceed the actual material thickness of the sealing body 4 are also conceivable.

FIG. 6, in a manner similar to FIG. 2, shows the isobars which indicate the surface pressure between the sealing body 4 and the object 2 to be sealed. The profile of the elevations 6b that form the elements 6 can also be seen in this illustration.

The elevations 6b, in a manner similar to that of the depressions 6a, can already be generated in the primary forming of the sealing body 4, as described above. The elevations 6b could also be generated by applying an additional material to the sealing body 4.

In the case of the embodiment of the device 1 illustrated in FIGS. 7 and 8 the at least one element 6 which modifies the rigidity of the sealing body 4 is formed by a material 6c which is dissimilar to the material of the sealing body 4. The material 6c in the present case is a material having a higher rigidity than the material of the sealing body 4 such that an increase in the rigidity of the sealing body 4 results in the region of the element 6. On account thereof, an influence on the surface pressure between the sealing body 4 and the object 2 to be sealed can be achieved in a manner similar to the elevations 6b.

In order for the material 6c to be incorporated, the clearance can be generated in the sealing body 4 and the material 6c can be incorporated into said clearance, for example. However, it is also possible for the material 6c to be incorporated in the sealing body 4 already in the production of said sealing body 4, for example by means of casting, sintering, vulcanizing, or any other suitable method. Optionally, fibrous materials can also be used for the material 6c, said fibrous materials likewise being able to be incorporated in said material 6c already in the primary forming. The material 6c, in a manner similar to that of the elevations 6b, could also be generated by incorporating an additional material in the sealing body 4.

The isobars from which the surface pressure between the sealing body 4 and the object 2 to be sealed, and the profile of the elements 6 that is oblique to the longitudinal axis 3 and widens away from the circumferential edge 7 can be derived are depicted in FIG. 8 in a manner analogous to that of FIG. 2.

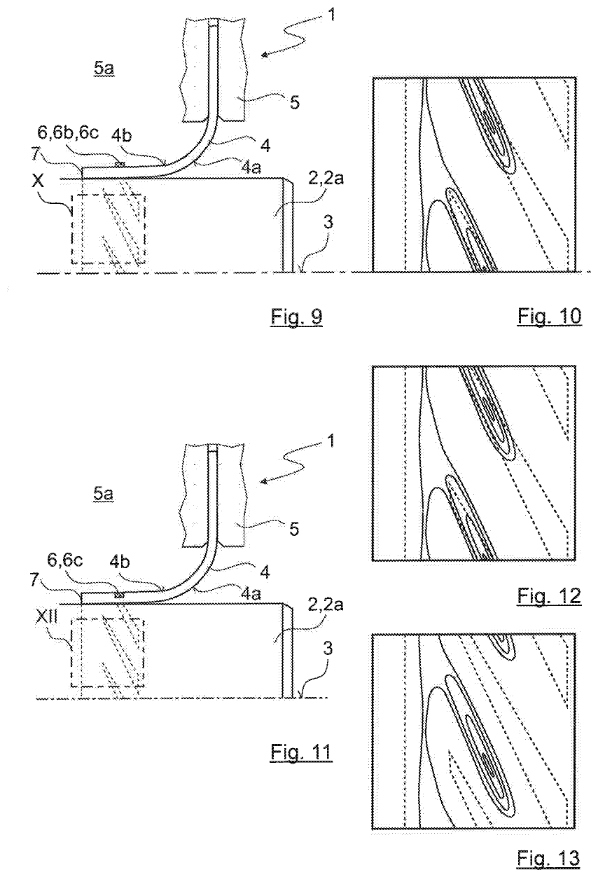

A combination of the embodiments of FIGS. 5 and 6, on the one hand, and of FIGS. 7 and 8, on the other hand, is illustrated in FIGS. 9 and 10. The element 6 which modifies the rigidity of the sealing body 4 is again formed by the elevation 6b herein wherein the elevation 6b in this case comprises the material 6c or is composed of the material 6c. On account thereof, an increase in the rigidity, having the effect on the surface pressure between the sealing body 4 and the object 2 to be sealed as already has been described above, results again in the region of the element 6, or in the region of the elements 6 that are disposed so as to be distributed about the circumference of the sealing body 4, respectively. The height of the elevation 6b can potentially be reduced by using a material 6c having a higher rigidity than the basic material of the sealing body 4.

The isobars representing the surface pressure between the sealing body 4 and the object 2 to be sealed are likewise illustrated in FIG. 10, and the profile of the elements 6 which also here is embodied so as to be oblique to the longitudinal axis 3 and so as to widen away from the circumferential edge 7 can again be seen.

The embodiment of the device 1 illustrated in FIGS. 11 to 13 is similar to those according to FIGS. 7 and 8, since the element 6 which modifies the rigidity of the sealing body 4 is again formed by the material 6c that is dissimilar from the material of the sealing body 4. Depending on the material used, a reduction or an increase in the rigidity of the sealing body 4 can be achieved herein in the respective region. A reduction in the rigidity in the region of the respective element 6 results when a material 6c having a lower rigidity than the material of the sealing body 4 is used. By contrast, an increase in the rigidity in the region of the respective element 6 results when a material 6c with a higher rigidity than the material of the sealing body 4 is used.

FIG. 12 herein, in each case by means of the isobars already described above, shows the case of an increase in the rigidity and thus an increase in the surface pressure between the sealing body 4 and the object 2 to be sealed, and FIG. 13 shows the case of a reduction in the rigidity and thus a reduction in the surface pressure between the sealing body 4 and the object to be sealed 2. The elements 6 widen away from the circumferential edge 7 and are moreover disposed obliquely to the longitudinal axis 3 also in the case of the embodiment of FIGS. 11, 12, and 13.

The at least one element 6 which modifies the rigidity of the sealing body 4 can also be configured as a cavity. Such a cavity can occupy, for example, 20% to 80% of the material thickness of the sealing body 4. The cavity can furthermore be filled with an additional material.

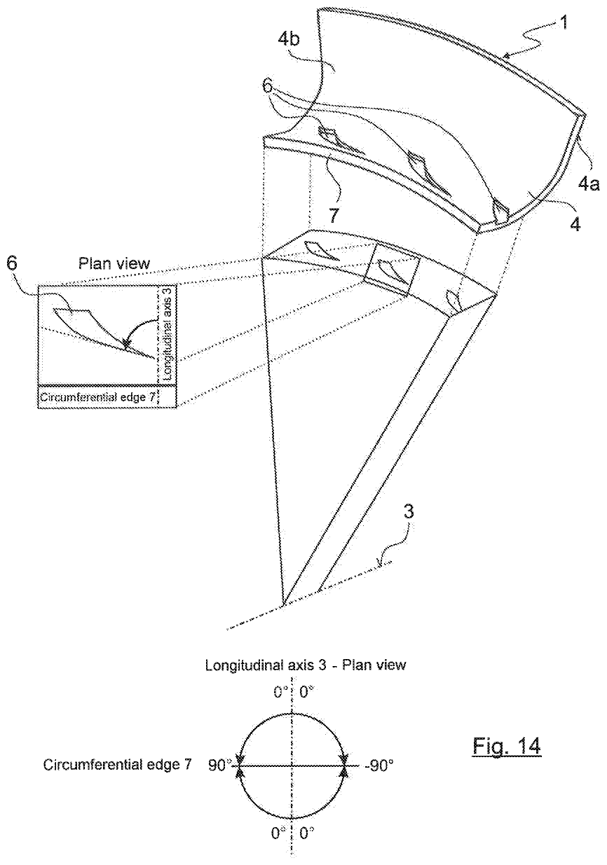

FIG. 14 shows the device from FIG. 3 in an illustration in which the profile of the depressions 6a, which is oblique to the longitudinal axis 3 of the rotating shall 2a, said longitudinal axis 3 also forming the longitudinal axis of the sealing body 4, is yet once again highlighted. The plan view of the sealing system herein is defined such that the circumferential edge of the sealing body 4 runs so as to be orthogonal to the longitudinal axis of the sealing body 4. The definition of the angles of the inclines in relation to the longitudinal axis of the sealing body 4, discussed above, can furthermore be derived from said figure. The illustration of FIG. 14 can of course be readily transferred to the case in which the elevation 6b or the cavity is used as the element 6 which modifies the rigidity of the sealing body 4.

The at least one element 6 which modifies the rigidity of the sealing body 4 in the plan view herein preferably runs obliquely at an angle between 0.1 and 89.9°, or between −89.9° and −0.1°, to the longitudinal axis of the sealing body 4.

An element 6 which modifies the rigidity of the sealing body 4 in the plan view (in a manner not illustrated) can run at a positive angle obliquely to the longitudinal axis of the sealing body 4, and an element 6 which modifies the rigidity of the sealing body 4 in the plan view can be disposed counter to the former, at a negative angle obliquely to the longitudinal axis of the sealing body.

It is furthermore imaginable that at least one element 6 which modifies the rigidity of the sealing body 4 has two inclines of which one, in the plan view, has a positive angle in relation to the longitudinal axis of the sealing body 4, and of which the other, in the plan view, has a negative angle in relation to the longitudinal axis of the sealing body 4.

Embodiments of the device 1 which are not illustrated in the figures but are readily imaginable include also conjointly rotating seal rings as well as externally sealing rings, thus rings which seal in relation to the component 5 or the housing, respectively. A further embodiment could be designed so as to seal in an axial manner, An improved sealing effect on account of the indirect structuring is also conceivable in the case of translatory movements.

The sealing bodies 4 can be produced by different manufacturing methods. In the case of primary forming methods, sintering, casting, for example injection molding, vulcanizing, exposing, etching and polymerizing, as well as all rapid prototyping and additive methods are expedient. In terms of forming, the seal rings can be embossed, stamped, forged, vacuum formed, blow molded, or pressed. Potential subtractive manufacturing methods include milling, boring, laser machining, cutting, adhesive bonding, punching. Potential joining methods include adhesive bonding, laminating, plating, soldering/brazing, or welding.

The functional principle of the device 1 can be implemented in particular by removing material, adding material, redistributing material, for example by embossing, modifying material, for example by reinforcing, softening, using fillers, woven-fabric reinforcement, foam structure, the use of dissimilar materials, for example in a laminate, and/or the effect of external forces, for example springs or compression members.

The details of the embodiments of the sealing body 4 described herein can in principle be combined with one another in an arbitrary manner, to the extent that there are no obvious reasons against a specific combination. Accordingly, it would also be possible for part of the elements 6 to be embodied as depressions 6a and another part to be embodied as elevations 6b on one and the same sealing body 4. A combination with the material 6c that is dissimilar to the material of the sealing body 4 would also be conceivable. The number, the disposal, and the embodiment of the elements 6 can be adapted to the respective specific application.

1. A device for sealing an object to be sealed, in particular for sealing a rotating shaft, having a sealing body which has a sealing side that faces the object to be sealed, and a rear side that faces away from the object to be sealed,
characterized in that
the sealing body on the rear side has at least one element which modifies the rigidity of the sealing body and which modifies the surface pressure between the sealing body and the object to be sealed, and in that the at least one element which modifies the rigidity of the sealing body runs obliquely to a longitudinal axis of the sealing body.

2. The device as claimed in claim 1,
characterized in that
a plurality of elements which modify the rigidity of the sealing body are disposed so as to be distributed about the circumference of the sealing body.

3. The device as claimed in claim 1,
characterized in that
the at least one element which modifies the rigidity of the sealing body has a spacing from a circumferential edge of the sealing body.

4. The device as claimed in claim 1,
characterized in that
the at least one element which modifies the rigidity of the sealing body is configured by a modification of the material thickness of the sealing body.

5. The device as claimed in claim 4,
characterized in that
the at least one element which modifies the rigidity of the sealing body is configured as a depression.

6. The device as claimed in claim 5,
characterized in that
the at least one depression has a height profile.

7. The device as claimed in claim 5,
characterized in that
the depression has a depth of 10 to 90%, preferably 30 to 90%, of the material thickness of the sealing body.

8. The device as claimed in one of claim 4,
characterized in that
the at least one element which modifies the rigidity of the sealing body is configured as an elevation.

9. The device as claimed in claim 8,
characterized in that
the at least one elevation has a height profile.

10. The device as claimed in claim 8,
characterized in that
the elevation exceeds the material thickness of the sealing body by 5 to 100%, preferably 25 to 100%.

11. The device as claimed in claim 1,
characterized in that
the at least one element which modifies the rigidity of the sealing body is formed by a material that is dissimilar to the material of the sealing body.

12. The device as claimed in claim 1,
characterized in that
the at least one element which modifies the rigidity of the sealing body in the plan view runs obliquely at an angle between 0.1° and 89.9°, or between −89.9° and −0.1°, to the longitudinal axis of the sealing body.

13. The device as claimed in claim 1,
characterized in that
the at least one element which modifies the rigidity of the sealing body is composed of a plurality of geometric basic shapes.

14. The device as claimed in claim 1,
characterized in that
at least one element which modifies the rigidity of the sealing body in the plan view runs obliquely at a positive angle to the longitudinal axis of the sealing body, and at least one element which modifies the rigidity of the sealing body in the plan view is disposed, counter to the former, obliquely at a negative angle to the longitudinal axis of the sealing body.

15. The device as claimed in claim 1,
characterized in that
the at least one element which modifies the rigidity of the sealing body has two inclines of which one, in the plan view, has a positive angle in relation to the longitudinal axis of the sealing body, and of which the other, in the plan view, has a negative angle in relation to the longitudinal axis of the sealing body.

16. The device as claimed in claim 2,
characterized in that
at least one of the elements which modifies the rigidity of the sealing body and which is disposed so as to be distributed about the circumference of the sealing body, in the plan view, runs in a direction counter to the other elements which modify the rigidity of the sealing body, in the plan view obliquely to the longitudinal axis of the sealing body.

17. The device as claimed in claim 1,
characterized in that
the at least one element which modifies the rigidity of the sealing body widens away from a circumferential edge of the sealing body.

18. The device as claimed in claim 1,
characterized in that
the sealing body comprises polytetrafluorethylene.

19. The device as claimed in claim 1,
characterized in that
the sealing body on the sealing side is configured so as to be substantially smooth.

20. The device as claimed in claim 1,
characterized in that
the at least one element which modifies the rigidity of the sealing body is configured as a cavity.

21. The device as claimed in claim 20,
characterized in that
the cavity occupies 20% to 80% of the material thickness of the sealing body.

22. The device as claimed in claim 20
characterized in that
the cavity is filled with an additional material.
